(19) United States
(12) Patent Application Publication
(10) Pub. No.: US 2010/0066806 A1
(43) Pub. Date: Mar. 18, 2010

(54) INTERNET VIDEO IMAGE PRODUCING METHOD

(75) Inventor: Szu-Hao Lyu, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/271,353

(22) Filed: Nov. 14, 2008

(30) Foreign Application Priority Data
Sep. 12, 2008 (TW) 097134980

(51) Int. Cl. H04N 7/14

(52) U.S. Cl. 348/14.08; 348/E07.077

(57) ABSTRACT

An internet video image producing method includes the following steps. Firstly, multiple images are captured by multiple web cameras. Then, the multiple images are compressed into compressed images. The compressed images are then combined as a single meeting image. Afterwards, the meeting image is transmitted to multiple screens.

### FIELD OF THE INVENTION

The present invention relates to an internet video image producing method, and more particularly to an internet video image producing method for use in a video conference.

### BACKGROUND OF THE INVENTION

Conventionally, people are communicated with each other through letters, indoor telephones, public telephones, beepers (also referred as pagers or B.B Call), faxing machines and the like. With increasing development of computer systems and networks, communication technologies have experienced great growth. Nowadays, the communicating ways are not restricted to letters, telephones, short messages or facsimile. For example, electronic mails gradually replace letters; and mobiles and instant messages gradually replace telephones and beepers.

Electronic mails are transferred among different computers through internet connection. In addition, through internet connection, a communication platform such as a blog or a network communication program also provides the communicating functions. In this context, the network communication program is concerned. The network communication program such as MSN Messenger, Yahoo Messenger and Skype program becomes popular instant message tool. By means of texts, symbols or pictures, the users of the network communication program can be communicated with each other. Moreover, some network communication programs can be executed to perform a videoconferencing function. Through the video conference, the users of different cities or countries can speak with each other. In other words, the videoconferencing technique enables low-cost face-to-face business meetings by saving long-distance call fees, international direct dialing fees, transportation fees and other fees required for face-to-face business meetings.

A video conference between two users will be illustrated as follows. When a network communication program is executed to perform a videoconferencing function, the microphone of the computer system can record a first user's speech and the web camera (or webcam) of the computer system can capture the first user's image. By the network communication program, the first user's speech and the first user's image are transmitted to the computer system of a second user through internet connection. The first user's speech and the first user's image are then respectively outputted by the loudspeaker and the screen of the second user's computer system. Similarly, the second user's speech and the second user's image can be obtained by the second user's computer system and then transmitted to the first user. Under this circumstance, the videoconferencing technique will enable individual users in faraway sites to have meetings.

On the other hands, although the conventional videoconferencing technique provides a one-to-one face-to-face business meeting, the conventional videoconferencing technique is not satisfactory to offer a one-to-many face-to-face business meeting. That is, if three (or more) users participate in the video conference, the videoconferencing technique becomes more complicated.

In a case that all of the three users are located at different sites, the first user can simultaneously communicate with the second user and the third user by using different frames; but the second user and the third user fail to communicate with each other by videoconferencing.

In another case that the first user is located at a first site but the second and third users are located at a second site, a collective web camera is required to capture the images of the second and third users. Under this circumstance, the second and third users need to be crowded into the shooting range of the web camera in order to capture the images of the second and third users. If the second and third users do not want to be simultaneously crowded into the shooting range of the web camera, the second and third users should take turns to move within the shooting range of the web camera upon marking a speech. As known, such a videoconferencing technique is neither user-friendly nor convenient.

Therefore, there is a need of providing an internet video image producing method for use in a video conference so as to obviate the drawbacks encountered from the prior art.

### SUMMARY OF THE INVENTION

It is an object of the present invention to provide an internet video image producing method for showing multiple users' images on a same meeting image.

In accordance with an aspect of the present invention, there is provided an internet video image producing method. Firstly, a first computer, a second computer and a third computer are communicated with an internet server through internet connection. Next, a first image, a second image and a third image are captured by a first web camera of the first computer, a second web camera of the second computer and a third web camera of the third computer, respectively. The first image, the second image and the third image are then transmitted to the internet server. Next, a video image combination application program of the internet server is executed to compress the first image, the second image and the third image into a first compressed image, a second compressed image and a third compressed image, respectively. The first compressed image, the second compressed image and the third compressed image are combined as a meeting image, so that the first compressed image, the second compressed image and the third compressed image are simultaneously shown on the meeting image. Afterwards, the meeting image is transmitted to the first computer, the second computer and the third computer.

In an embodiment, the first image, the second image and the third image are stored in a memory of the internet server.

In an embodiment, the first compressed image, the second compressed image and the third compressed image are combined as the meeting image by the video image combination application program, and the meeting image is stored in the memory.

In an embodiment, the first computer, the second computer and the third computer are desktop computers or notebook computers.

In an embodiment, the first computer, the second computer and the third computer include a first screen, a second screen and a third screen for respectively displaying the meeting image that is transmitted to the first computer, the second computer and the third computer.

In accordance with an aspect of the present invention, there is provided an internet video image producing method. Firstly, a first computer is communicated with a second computer through internet connection, wherein the first computer has a first web camera, and the second computer is communicated with a second web camera and a third web camera. Next, a first image, a second image and a third image are captured by the first web camera, the second web camera and the third web camera, respectively. The first image, the second image and the third image are then transmitted to the second computer. Next, a video image combination application program of the internet server is executed to compress the first image, the second image and the third image into a first compressed image, a second compressed image and a third compressed image, respectively. The first compressed image, the second compressed image and the third compressed image are combined as a meeting image, so that the first compressed image, the second compressed image and the third compressed image are simultaneously shown on the meeting image. Afterwards, the meeting image is transmitted to the first computer and a screen that is connected to the second computer.

In an embodiment, the first image, the second image and the third image are stored in a memory of the second computer.

In an embodiment, the meeting image is stored in the memory.

In an embodiment, the first computer and the second computer are desktop computers or notebook computers.

In an embodiment, the second computer further includes multiple USB connecting ports, and the second computer is communicated with the second web camera and the third web camera through the USB connecting ports.

In an embodiment, the second computer further includes a USB expander with multiple USB connecting ports, and the second computer is communicated with the second web camera and the third web camera through the USB expander.

In an embodiment, the first computer includes a first screen for displaying the meeting image that is transmitted to the first computer.

In an embodiment, the screen of the second computer is a projection screen for displaying the meeting image that is transmitted to the second computer.

In accordance with a further aspect of the present invention, there is provided an internet video image producing method. Firstly, a first image, a second image and a third image are generated and outputted by a first computer, a second computer and a third computer, respectively. Next, the first image, the second image and the third image are compressed into a first compressed image, a second compressed image and a third compressed image, respectively. The first compressed image, the second compressed image and the third compressed image are combined as a meeting image, so that the first compressed image, the second compressed image and the third compressed image are simultaneously shown on the meeting image. Afterwards, the meeting image is transmitted to the first computer, the second computer and the third computer.

In an embodiment, the first computer, the second computer and the third computer further includes a first web camera, a second web camera and a third web camera for capturing and generating the first image, the second image and the third image, respectively.

In an embodiment, the first image, the second image and the third image are respectively transmitted from the first computer, the second computer and the third computer to a memory of the internet server through internet connection.

In an embodiment, the meeting image is stored in the memory.

In an embodiment, the first computer, the second computer and the third computer are desktop computers or notebook computers.

In an embodiment, the first computer, the second computer and the third computer include a first screen, a second screen and a third screen for respectively displaying the meeting image that is transmitted to the first computer, the second computer and the third computer.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic block functional diagram illustrating a videoconferencing system according to a first preferred embodiment of the present invention; and

FIG. 2 is a schematic block functional diagram illustrating a videoconferencing system according to a second preferred embodiment of the present invention.

### DETAILED DESCRIPTION OF THE PREFERRED EMBODIMENT

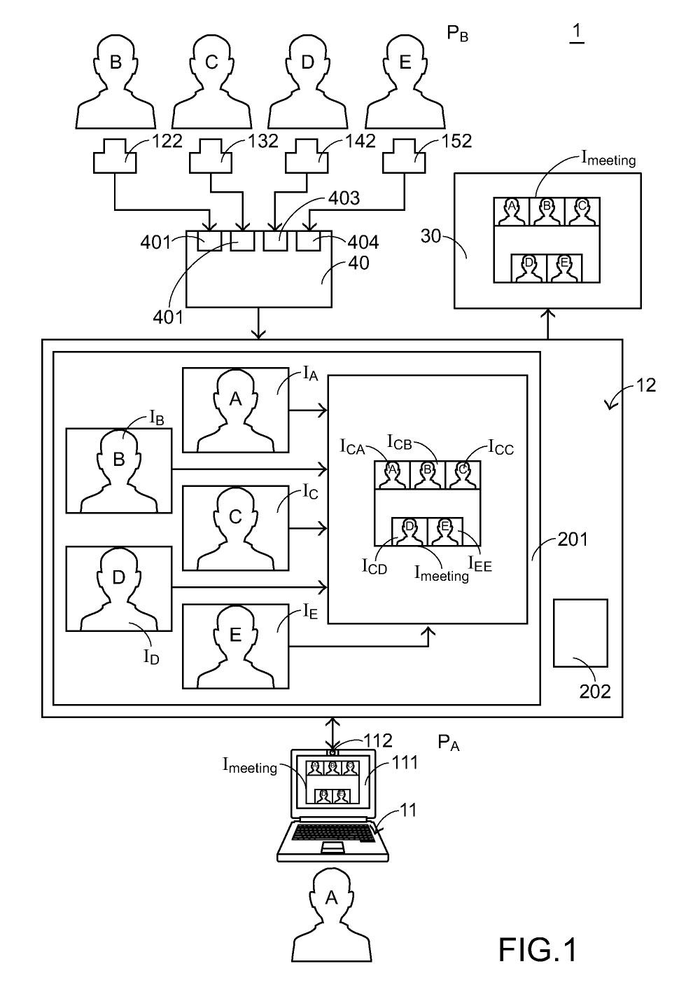

The present invention provides an internet video image producing method for use in a video conference. FIG. 1 is a schematic block functional diagram illustrating a videoconferencing system according to a first preferred embodiment of the present invention. In this embodiment, a user at a first site and multiple other users at a second site participate in a video conference. As shown in FIG. 1, a first user A is located at a first site PA; but a second user B, a third user C, a fourth user D and a fifth user E are located at a second site PB. For example, the second site PB is a conference room. The videoconferencing system 1 principally comprises a first computer 11 and a second computer 12. The first computer 11 is located at the first site PA. The second computer 12 is located at the second site PB (i.e. the conference room). The second computer 12 comprises a memory 201 and a video image combination application program 202. In addition, the second computer 12 is connected to a projection screen 30. For preventing the four users at the second site PB from being crowded into the shooting range of only a web camera, four web cameras are respectively disposed in front of these four users. Please refer to FIG. 1 again. A second web camera 122 is disposed in front of the second user B for capturing the image of the second user B. A third web camera 132 is disposed in front of the third user C for capturing the image of the third user C. A fourth web camera 142 is disposed in front of the fourth user D for capturing the image of the fourth user D. A fifth web camera 152 is disposed in front of the fifth user E for capturing the image of the fifth user E. These web cameras 122, 132, 142 and 152 are all electrically connected to the second computer 12. An example of the second computer 12 that is disposed at the second site PB is a desktop computer. The first computer 11, which is disposed at the first site PA and used by the first user A, comprises a first screen 111 and a first web camera 112.

Hereinafter, a process of carrying out internet video image producing method according to the present invention will be illustrated with reference to the videoconferencing system of FIG. 1. For a purpose of having a face-to-face business meeting between the first user A and the other four users B˜E, the first computer 11 is communicated with the second computer 12 through internet connection. Next, a first image I_{A} of the first user A is captured by the first web camera 112 of the first computer 11. At the same time, a second image I_{B} of the second user B, a third image I_{C} of the third user C, a fourth image I_{D} of the fourth user D and a fifth image I_{E} of the fifth user E are respectively captured by the second web camera 122, the third web camera 132, the fourth web camera 142 and the fifth web camera 152, which are disposed at the second side PB. Generally, the web camera may be directly connected to the USB connecting port of a computer. Since the amount of web cameras to be communicated with the second computer 12 is more than the inherent USB connecting port of the second computer 12, a USB expander 40 is required. That is, the web cameras 122, 132, 142 and 152 that are disposed on the second side PB are connected to the second computer 12 through the USB expander 40. The second web camera 122 is connected to a first USB connecting port 401 of the USB expander 40. The third web camera 132 is connected to a second USB connecting port 402 of the USB expander 40. The fourth web camera 142 is connected to a third USB connecting port 403 of the USB expander 40. The fifth web camera 152 is connected to a fourth USB connecting port 404 of the USB expander 40.

After the images have been captured, the first image I_{A} is transmitted from the first computer 11 to the memory 201 of the second computer 12 through internet connection for storage. In addition, the images I_{B}, I_{C}, I_{D} and I_{E} that are respectively captured by the web cameras 122, 132, 142 and 152 at the second side PB are transmitted to the memory 201 of the second computer 12 through physical wires for storage. It is preferred that the images I_{A}, I_{B}, I_{C}, I_{D} and I_{E} are captured at 640×480 resolution. Next, the video image combination application program 202 is executed to compress the images I_{A}, I_{B}, I_{C}, I_{D} and I_{E} into a first compressed image I_{CA}, a second compressed image I_{CB}, a third compressed image I_{CC}, a fourth compressed image I_{CD} and a fifth compressed image I_{CE}, respectively. The compressed images I_{CA}, I_{CB}, I_{CC}, I_{CD} and I_{CE} have resolution lower than 640×480. Next, by the video image combination application program 202, these compressed images I_{CA}, I_{CB}, I_{CC}, I_{CD} and I_{CE} are combined as a meeting image I_{meeting}. The meeting image I_{meeting} comprises the first compressed image I_{CA}, the second compressed image I_{CB}, the third compressed image I_{CC}, the fourth compressed image I_{CD} and the fifth compressed image I_{CE}. That is, the first compressed image I_{CA}, the second compressed image I_{CB}, the third compressed image I_{CC}, the fourth compressed image I_{CD} and the fifth compressed image I_{CE} are simultaneously shown on the meeting image I_{meeting} in a predetermined arrangement as shown in FIG. 1. Also, the meeting image I_{meeting} is obtained at 640×480 resolution.

Next, the meeting image I_{meeting} is transmitted to the first screen 111 of the first computer 11, so that the meeting image I_{meeting} is displayed on the first screen 111 to be viewed by the first user A. In addition, the meeting image I_{meeting} is also transmitted to the projection screen 30, which is connected to the second computer 12, so that the meeting image I_{meeting} is displayed on the projection screen 30 to be simultaneously viewed by the users B˜E at the second site PB. Since the compressed images of all users are combined as the single meeting image I_{meeting} and the meeting image I_{meeting} is transmitted to the screens at different sites, the images of all attendants in the video conference can be viewed by all users. Consequently, a one-to-many face-to-face business meeting is feasible by using the internet video image producing method of the present invention. Under this circumstance, since the users no longer needs to take turns to move or be crowded within the shooting range of the collective web camera, the problems encountered from the prior art are overcome.

In this embodiment, the compressed images of the meeting image I_{meeting} are organized in the predetermined arrangement as shown in FIG. 1. Nevertheless, the compressed images of the meeting image I_{meeting} may be organized in any desired arrangement. The internet video image producing method of the present invention enables individual users in faraway sites to have meetings while solving the problems encountered from the prior art.

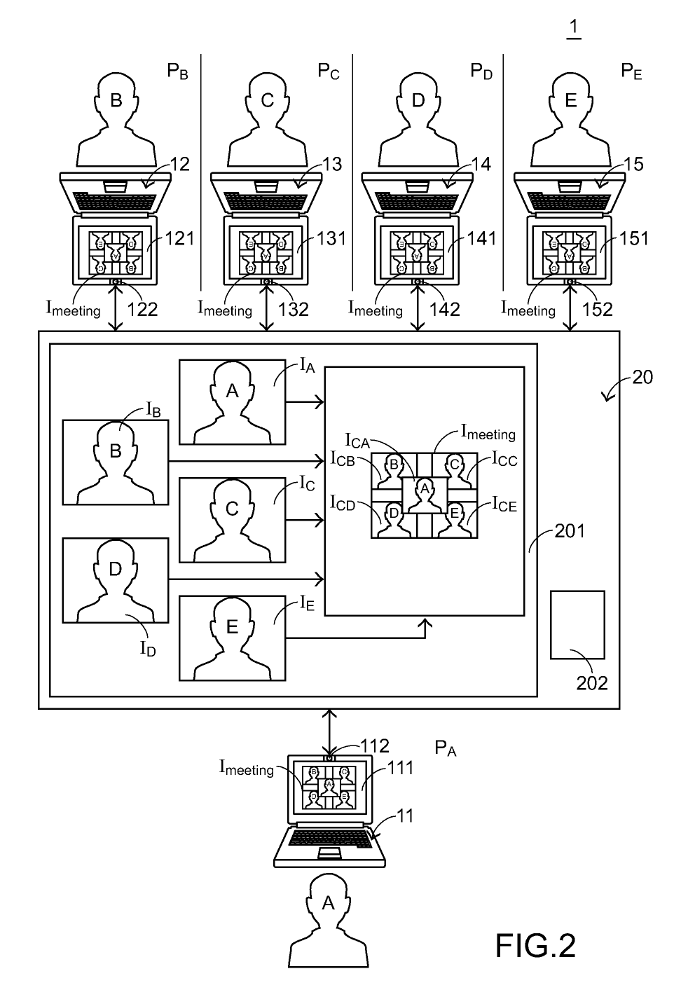

FIG. 2 is a schematic block functional diagram illustrating a videoconferencing system according to a second preferred embodiment of the present invention. In this embodiment, the users for participating in a video conference are located at different sites. As shown in FIG. 2, a first user A is located at the first site PA; a second user B is located at a second site PB; a third user C is located at a third site PC; a fourth user D is located at a fourth site PD; and a fifth user E is located at a fifth site PE. The videoconferencing system 1 principally comprises an internet server 20, a first computer 11, a second computer 12, a third computer 13, a fourth computer 14 and a fifth computer 15. The first computer 11 is located at the first site PA. The second computer 12 is located at the second site PB. The third computer 13 is located at the third site PC. The fourth computer 14 is located at the fourth site PD. The fifth computer 15 is located at the fifth site PE. The internet server 20 comprises a memory 201 and a video image combination application program 202. In this embodiment, the computers 11, 12, 13, 14 and 15 are notebook computers with built-in web cameras. The first computer 11 comprises a first screen 111 and a first web camera 112. The second computer 12 comprises a second screen 121 and a second web camera 122. The third computer 13 comprises a third screen 131 and a third web camera 132. The fourth computer 14 comprises a fourth screen 141 and a fourth web camera 142. The fifth computer 15 comprises a fifth screen 151 and a fifth web camera 152.

Hereinafter, a process of carrying out internet video image producing method according to the present invention will be illustrated with reference to the videoconferencing system of FIG. 2. For a purpose of having a face-to-face business meeting between the first user A and the other four users B˜E, the first computer 11 is communicated with the internet server 20 through internet connection. Likewise, the computers 12, 13, 14 and 15 are also communicated with the internet server 20 through internet connection. Next, a first image I_{A} of the first user A is captured by the first web camera 112 of the first computer 11; a second image I_{B} of the second user B is captured by the second web camera 122 of the second computer 12; a third image I_{C} of the third user C is captured by the third web camera 132 of the third computer 13; a fourth image I_{D} of the fourth user D is captured by the fourth web camera 142 of the fourth computer 14; and a fifth image I_{E} of the fifth user E is captured by the fifth web camera 152 of the fifth computer 15. It is preferred that the images I_{A}, I_{B}, I_{C}, I_{D} and I_{E} are captured at 640×480 resolution. After the images have been captured, the first image I_{A}, the second image I_{B}, the third image I_{C}, the fourth image I_{D} and the fifth image I_{E} are transmitted to the memory 201 of the internet server 20 for storage through internet connection. Next, the video image combination application program 202 of the internet server 20 is executed to compress the images I_{A}, I_{B}, I_{C}, I_{D} and I_{E} into a first compressed image I_{CA}, a second compressed image I_{CB}, a third compressed image I_{CC}, a fourth compressed image I_{CD} and a fifth compressed image I_{CE}, respectively. The compressed images I_{CA}, I_{CB}, I_{CC}, I_{CD} and I_{CE} have resolution of 320×240. Next, by the video image combination application program 202, these compressed images I_{CA}, I_{CB}, I_{CC}, I_{CD} and I_{CE} are combined as a meeting image I_{meeting}. The meeting image I_{meeting} comprises the first compressed image I_{CA}, the second compressed image I_{CB}, the third compressed image I_{CC}, the fourth compressed image I_{CD} and the fifth compressed image I_{CE}. That is, the first compressed image I_{CA}, the second compressed image I_{CB}, the third compressed image I_{CC}, the fourth compressed image I_{CD} and the fifth compressed image I_{CE} are simultaneously shown on the meeting image I_{meeting} in a predetermined arrangement as shown in FIG. 2.

Next, the meeting image I_{meeting} is transmitted to the first computer 11, the second computer 12, the third computer 13, the fourth computer 14 and the fifth computer 15, so that the meeting image I_{meeting} is shown on the first screen 111, the second screen 121, the third screen 131, the fourth screen 141 and the fifth screen 151 to be respectively viewed by the users A˜E. Meanwhile, the images of all attendants in the video conference can be viewed by all users and thus more than two people can have a face-to-face business meeting. In this embodiment, the images I_{A}, I_{B}, I_{C}, I_{D} and I_{E} captured at 640×480 resolution are compressed by the video image combination application program 202 into the compressed images I_{CA}, I_{CB}, I_{CC}, I_{CD} and I_{CE} at 320×240 resolution, and these compressed images I_{CA}, I_{CB}, I_{CC}, I_{CD} and I_{CE} are then combined as a meeting image I_{meeting}. The meeting image I_{meeting} is also obtained at 640×480 resolution.

In this embodiment, the compressed images of the meeting image I_{meeting} are organized in an arrangement other than FIG. 1. The resolution of the compressed images is not restricted as long as the resolution of the compressed images is lower than the resolution of the original images. In addition, the original images and the meeting image I_{meeting} are not restricted to be obtained at 640×480 resolution.

From the above description, the internet video image producing method of the present invention can be used to have one-to-many or many-to-many face-to-face business meetings. By means of the specified video image combination application program, the internet video image producing method of the present invention is applicable to the existing hardware components without the need of additional cost. The internet video image producing method of the present invention needs large-sized memory capacity and relatively broad network bandwidth, which are achievable by the current computing techniques. As the current computing techniques are continuously developed, the efficacy of the present invention becomes more apparent.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An internet video image producing method comprising:
communicating a first computer, a second computer and a third computer with an internet server through internet connection;
capturing a first image, a second image and a third image by a first web camera of said first computer, a second web camera of said second computer and a third web camera of said third computer, respectively, and transmitting said first image, said second image and said third image to said internet server;
executing a video image combination application program of said internet server to compress said first image, said second image and said third image into a first compressed image, a second compressed image and a third compressed image, respectively, and combining said first compressed image, said second compressed image and said third compressed image as a meeting image, so that said first compressed image, said second compressed image and said third compressed image are simultaneously shown on said meeting image; and
transmitting said meeting image to said first computer, said second computer and said third computer.

2. The internet video image producing method according to claim 1 wherein said first image, said second image and said third image are stored in a memory of said internet server.

3. The internet video image producing method according to claim 2 wherein said first compressed image, said second compressed image and said third compressed image are combined as said meeting image by said video image combination application program, and said meeting image is stored in said memory.

4. The internet video image producing method according to claim 1 wherein said first computer, said second computer and said third computer are desktop computers or notebook computers.

5. The internet video image producing method according to claim 1 wherein said first computer, said second computer and said third computer comprise a first screen, a second screen and a third screen for respectively displaying said meeting image that is transmitted to said first computer, said second computer and said third computer.

6. An internet video image producing method comprising:
communicating a first computer with a second computer through internet connection, wherein said first computer has a first web camera, and said second computer is communicated with a second web camera and a third web camera;
capturing a first image, a second image and a third image by said first web camera, said second web camera and said third web camera, respectively, and transmitting said first image, said second image and said third image to said second computer;
executing a video image combination application program of said second computer to compress said first image, said second image and said third image into a first compressed image, a second compressed image and a third compressed image, respectively, and combining said first compressed image, said second compressed image and said third compressed image as a meeting image, so that said first compressed image, said second compressed image and said third compressed image are simultaneously shown on said meeting image; and
transmitting said meeting image to said first computer and a screen that is connected to said second computer.

7. The internet video image producing method according to claim 6 wherein said first image, said second image and said third image are stored in a memory of said second computer.

8. The internet video image producing method according to claim 7 wherein said meeting image is stored in said memory.

9. The internet video image producing method according to claim 6 wherein said first computer and said second computer are desktop computers or notebook computers.

10. The internet video image producing method according to claim 6 wherein said second computer further comprises multiple USB connecting ports, and said second computer is communicated with said second web camera and said third web camera through said USB connecting ports.

11. The internet video image producing method according to claim 6 wherein said second computer further comprises a USB expander with multiple USB connecting ports, and said second computer is communicated with said second web camera and said third web camera through said USB expander.

12. The internet video image producing method according to claim 6 wherein said first computer comprises a first screen for displaying said meeting image that is transmitted to said first computer.

13. The internet video image producing method according to claim 6 wherein said screen of said second computer is a projection screen for displaying said meeting image that is transmitted to said second computer.

14. An internet video image producing method comprising:
generating and outputting a first image, a second image and a third image by a first computer, a second computer and a third computer, respectively;
compressing said first image, said second image and said third image into a first compressed image, a second compressed image and a third compressed image, respectively, and combining said first compressed image, said second compressed image and said third compressed image as a meeting image, so that said first compressed image, said second compressed image and said third compressed image are simultaneously shown on said meeting image; and
transmitting said meeting image to said first computer, said second computer and said third computer.

15. The internet video image producing method according to claim 14 wherein said first computer, said second computer and said third computer further comprises a first web camera, a second web camera and a third web camera for capturing and generating said first image, said second image and said third image, respectively.

16. The internet video image producing method according to claim 14 wherein said first image, said second image and said third image are respectively transmitted from said first computer, said second computer and said third computer to a memory of said internet server through internet connection.

17. The internet video image producing method according to claim 16 wherein said meeting image is stored in said memory.

18. The internet video image producing method according to claim 14 wherein said first computer, said second computer and said third computer are desktop computers or notebook computers.

19. The internet video image producing method according to claim 14 wherein said first computer, said second computer and said third computer comprise a first screen, a second screen and a third screen for respectively displaying said meeting image that is transmitted to said first computer, said second computer and said third computer.
